(19) United States
(12) Patent Application Publication
(10) Pub. No.: US 2014/0049209 A1
(43) Pub. Date: Feb. 20, 2014

(54) CHARGING CONVERTER

(71) Applicants: Chin-Ching CHANG, Taipei (TW); Heng-Chuan CHEN, Taipei (TW); Xuan-Ni HONG, Taipei (TW)

(72) Inventors: Chin-Ching CHANG, Taipei (TW); Heng-Chuan CHEN, Taipei (TW); Xuan-Ni HONG, Taipei (TW)

(21) Appl. No.: 13/587,395

(22) Filed: Aug. 16, 2012

(51) Int. Cl. H02J 7/00

(52) U.S. Cl. 320/107

(57) ABSTRACT

A charging converter has a first protocol interface and a second protocol interface mounted on a body. The body further has a switching circuit. Each of the first protocol interface and the second protocol interface has a power pin, a ground pin and two data pins. The power pin of the first protocol interface is connected to the power pin of the second protocol interface. The data pins of the second protocol interface are connected to the data pins of the first protocol interface through the switching circuit. The switching circuit serves to switch to a synchronous mode or a fast charging mode. When the synchronous mode is selected, the power and data channels between the first protocol interface and the second protocol interface are simultaneously established. When the fast charging mode is selected, only the power channel is established to accelerate the charging speed.

### BACKGROUND OF THE INVENTION

1. Field of the Invention

The present invention relates to a charging converter and more particularly to a charging converter switchable between a data transfer and charging mode and a fast charging mode.

2. Description of the Related Art

Cell phones have already become one of the most indispensable communication tools of modern people. In view of the huge market potential, all major leading cell phone manufacturers make every endeavor to develop new types of cells phones to stimulate the consumers' urge to buy. The outcome of such competition also leads to waste of resources. As far as the replacement rate of cell phone is concerned, a quite high portion of users easily changes their cell phones within a very short period of time. However, the charging sockets available to the cell phones of all major leading cell phone manufacturers all had proprietary specifications in the past. Besides, the charging sockets used by different models of cell phones made by a same manufacturer may not be interchangeable. Under the circumstance, a new cell phone out of the factory usually needs to come with a proprietary charger dedicated to the cell phone, and the chargers of old cell phones inevitably become obsolete. Due to a large replacement rate of cell phone, the discarded chargers of cell phones is staggering in number. According to the statistical report announced by GSM Association (GSMA), 5.1 tons of chargers are repeatedly produced each year for the global market demand, and it ends up with serious waste of resources. To tackle the resource waste issue, GSMA announced on Feb. 17, 2009 that Micro-USB (Universal serial bus) has been standardized as a globally universal specification for charger interface by the end of year 2012, and European Union also passed the foregoing charger specification in the end of year 2010 to choose Micro-USB interface as the specification for the universal charging sockets of cell phones and will put into effect in year 2012. In other words, all new cell phones in the market must be equipped with a charging socket complying with Micro-USB. The standardization of the charging sockets is helpful in effectively solving the waste issue of resources, and the standby power consumed by the charger of each new cell phone is estimated to be 50% lower than that of an existing charger, thereby obtaining two gains with one move.

It is known to the persons ordinarily skilled in the art of the present invention, the USB interface is originally used as the technical specification of computer input/output interface. Therefore, in addition to a power pin (VBUS), a Micro-USB interface also has two data pins (D− and D+). As far as the interaction between a computer and regular peripheral equipment with a USB interface is concerned, the computer not only performs data communication with the USB peripheral equipment but also supplies power to the USB peripheral equipment. When data transmission and charging are performed simultaneously (herein referred to as a synchronous mode), the data transmission is of higher priority. As a result, the charging current is 500 mA and the charging speed is relatively slower. On the other hand, if there is no data transmission but pure charging (herein referred to a fast charging mode), the charging current goes up in a range of 700-800 mA. The charging current of a latest U3 USB interface can reach up to 900 mA so the charging speed is accelerated. However, the current Micro-USB interface, if not specially designed, is surely the synchronous mode when a cell phone is connected to a charger or a computer through a Micro-USB interface. To users requiring to just charge their cell phones, a longer charging time to wait is inevitable unless a specially designed charger is used.

From the foregoing, as the chargers of cell phones will adopt Micro-USB as the standard interface of the charging sockets, the cell phones having the USB specification can perform charging only at the synchronous mode, which is more time-consuming in charging operation, unless specially designed charger are used.

### SUMMARY OF THE INVENTION

An objective of the present invention is to provide a charging converter connected between a device to be charged and a charging device and providing a mode switching capability for users to select a synchronous mode or a fast charging mode depending users' demand and operate with more flexibility and convenience.

To achieve the foregoing objective, the A charging converter has a body, a first protocol interface, a second protocol interface and a switch.

The body has a switching circuit therein.

The first protocol interface is mounted on the body, is a USB-based interface, and has a power pin, a ground pin and two data pins.

The second protocol interface is mounted on the body and has a power pin, a ground pin and two data pins. The power pin is connected to the power pin of the first protocol interface. The ground pin is connected to the ground pin of the first protocol interface. The data pins are connected to the two data pins of the first protocol interface through the switching circuit.

The switch is mounted on the body, is connected to the switching circuit of the body, and selectively switches to enter a synchronous mode and a fast charging mode through the switching circuit. The power pin and the data pins of the first protocol interface are respectively connected to the power pin and the data pins of the second protocol interface at the synchronous mode, and the power pin of the first protocol interface is connected to the power pin of the second protocol interface at the fast charging mode.

The charging converter can be connected in series between a device to be charged and a charging device. Prior to the connection, the charging converter can select the synchronous mode or the fast charging mode through the switching circuit. When the fast charging mode is selected, the data channel between the charging device and the device to be charged is not established. Hence, the charging device can rapidly charge the device to be charged with higher charging current. The device to be charged may be a cell phone and the charging device may be a computer or a charger.

The benefits of the charging converter are as follows.

1. Users can conveniently choose the synchronous mode or the fast charging mode based on their demands.

2. When users select the fast charging mode, higher charging current is available to shorten the charging time.

3. The device to be charged is applicable to all sorts of chargers with USB output interfaces and requires no dedicated charger.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a charging converter in accordance with the present invention;

FIG. 2 is a circuit diagram of the charging converter in FIG. 1;

FIGS. 3A and 3B are operational circuit diagrams of the charging converter in FIG. 2;

FIG. 4 is another circuit diagram of the charging converter in FIG. 1;

FIG. 5 is a perspective view of a second embodiment of a charging converter in accordance with the present invention; and

FIG. 6 is a perspective view of a third embodiment of a charging converter in accordance with the present invention.

### DETAILED DESCRIPTION OF THE INVENTION

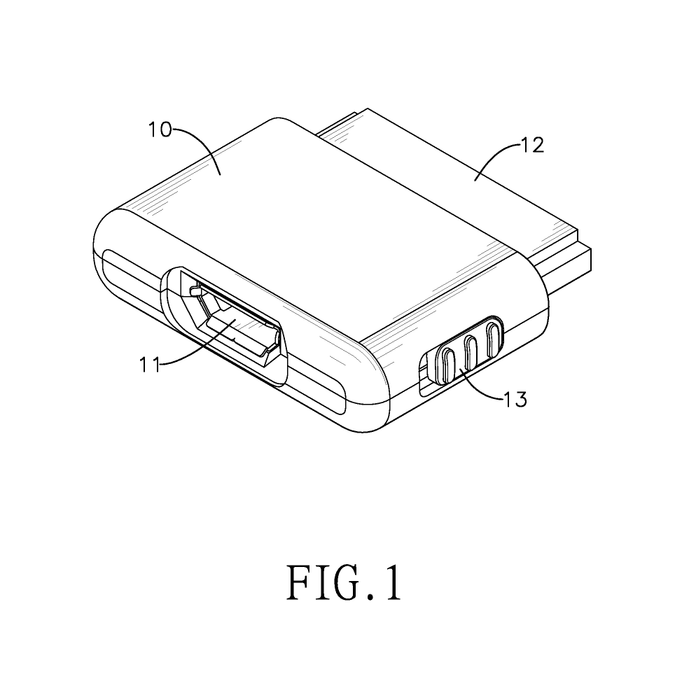

With reference to FIG. 1, a first embodiment of a charging converter in accordance with the present invention has a body 10, a first protocol interface 11, a second protocol interface 12 and a switch 13.

The first protocol interface 11 is mounted on a first end of the body 10 and is a USB-based interface. The second protocol interface 12 is mounted on a second end of the body 10 opposite to the first end. The switch 13 is mounted on one side of the body 10, and is connected to a switching circuit mounted inside the body 10.

In the present embodiment, the first protocol interface 11 is a Micro-B USB socket for a Micro-B USB plug to be plugged therein. The Micro-B USB socket has a power pin (VBUS), a ground pin (GND) and two data pins (D+ and D−). The second protocol interface 12 is a 30-pin connector, in particular, a communication interface used by iPhone® and iPad® manufactured by Apple Inc. The 30-pin connector at least has a power pins (BATV), a ground pin (GND) and two USB data pins (D+ and D−). The switch 13 is a mechanical switch collaborated with the switching circuit inside the body 10 to determine a connection state of the USB data pins (D+ and D−) of the second protocol interface 12.

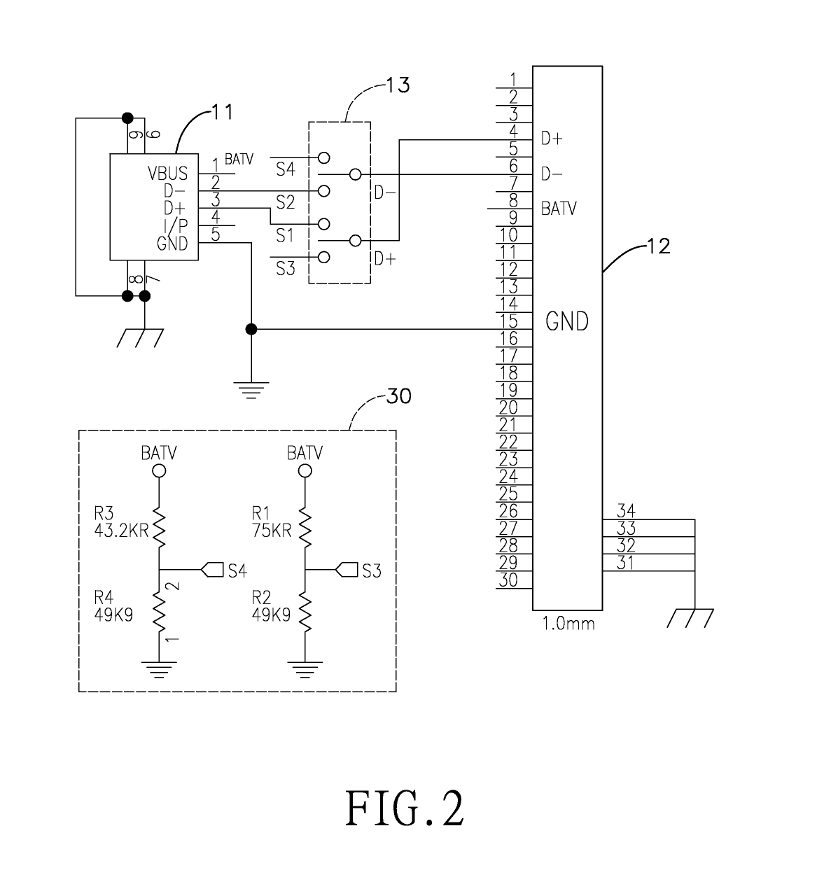

With reference to FIG. 2, the power pin VBUS of the first protocol interface 11 is connected to the power pin BATV of the second protocol interface 12. The switching circuit 30 may be implemented as two voltage divider circuits. One of the voltage divider circuits is composed of two voltage divider resistors R1, R2 connected in series and has a junction node connected with one end of each of the two voltage divider resistors R1, R2. The other end of one of the voltage divider resistors R1 is connected to the power pin BATV of the second protocol interface 12. The other end of the other voltage divider resistor R2 is connected to the ground. The other voltage divider circuit is composed of two voltage divider resistors R3, R4 connected in series and has a junction node connected with one end of each of the two voltage divider resistors R3, R4. The other end of one of the voltage divider resistors R3 is connected to the power pin BATV of the second protocol interface 12. The other end of the other voltage divider resistor R4 is connected to the ground.

The switch 13 is a two-way switch having two common points and four switch points S1, S2, S3 and S4. One of the common points is connected to one of the data pins D− of the second protocol interface 12 and corresponds to the switch points S2, S4, and the other common point is connected to the other data pin D+ and corresponds to the switch points S1, S3. The two switch points S2, S1 are connected to the data pins D+, D− of the first protocol interface 11. The switch points S3, S4 are respectively connected to the junction nodes of the two voltage divider circuits of the switching circuit 30.

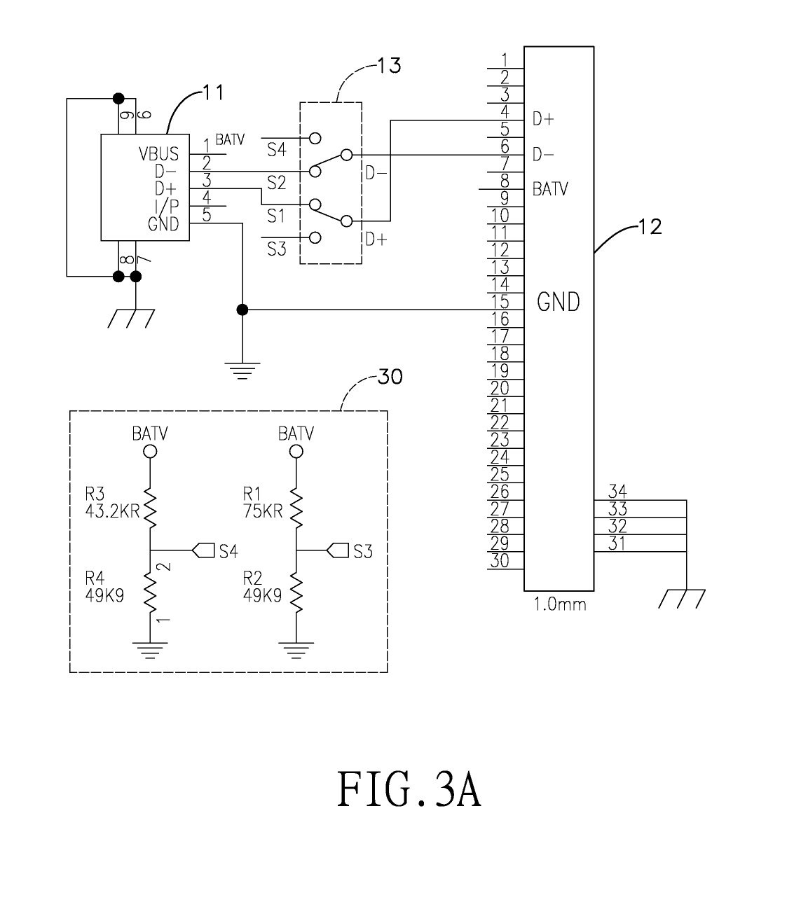

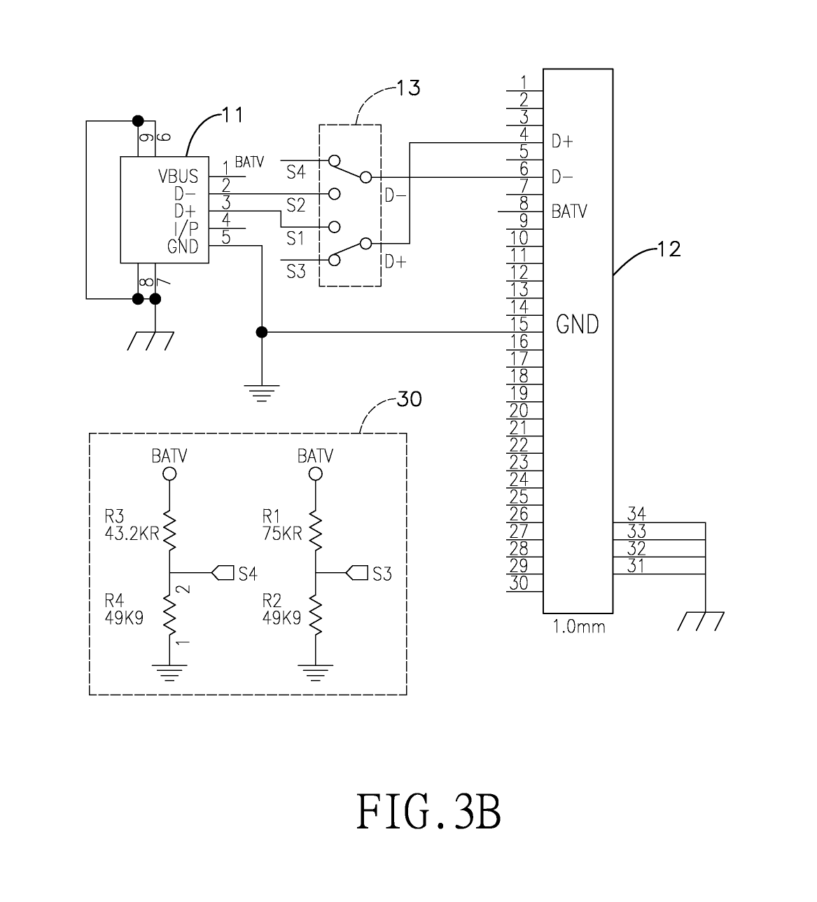

With reference to FIG. 3A, when users switch the switch 13 to enter a synchronous mode, the two data pins D+, D− of the second protocol interface 12 are respectively connected to the two data pins D+, D− of the first protocol interface 11 through the two common points and the two switch points S2, S1. Under the synchronous mode, the first protocol interface 11 and the second protocol interface 12 are respectively connected to a charging device and a device to be charged. Power and data channels are simultaneously formed between the charging device and the device to be charged. While the charging device charges the device to be charged, data transfer also occurs therebetween. The charging current is about 500 mA.

If users just have a charging demand, the switch 13 is switched to enter a fast charging mode for the first protocol interface 11 and the second protocol interface 12 to be respectively connected to the charging device and the device to be charged. With reference to FIG. 3B, under the fast charging mode, the two data pins D+, D− of the second protocol interface 12 are respectively connected to the junction nodes of the two voltage divider circuits of the switching circuit through the two common points and the two switch points S4, S3 for the data pins D+, D− of the device to be charged to acquire a specific voltage. As the data pins D+, D− of the first protocol interface 11 are disconnected from the data pins D+, D− of the second protocol interface 12. Only a power channel is formed between the charging device and the device to be charged. While the charging device charges the device to be charged, the charging current is about in a range of 700-1000 mA dependent on the type of the charging device.

From the foregoing, users can select either one of the synchronous mode and the fast charging mode depending on users' demand through the use of the charging converter of the present invention. When there is only a charging demand, the fast charging mode is selected to have a higher charging current for charging and the charging time is therefore shortened. Meanwhile, any charger meeting the power requirement of the charging device, for example at least voltage 5V/current 1 A) can be operated in collaboration with the charging converter of the present invention to charge the device to be charged without requiring a dedicated charger.

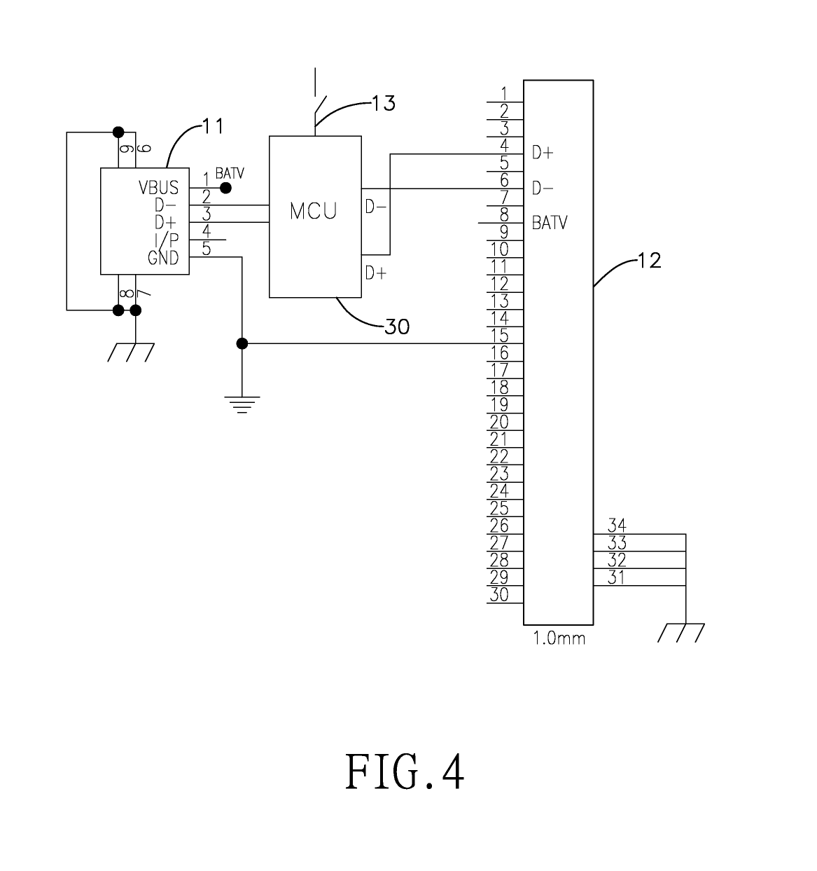

With reference to FIG. 4, the switching circuit 30 inside the body 10 may be composed of a micro-controller unit (MCU) so that the data pins of the first protocol interface 11 and the second protocol interface 12 are all connected to the MCU. The MCU controls the connection of the data pins of the first protocol interface 11 and the second protocol interface 12 according to a switching choice of the switch 13 to enter the fast charging mode or the synchronous mode. Similarly, a switching command can be issued from a computer to the charging converter to select the fast charging mode or the synchronous mode.

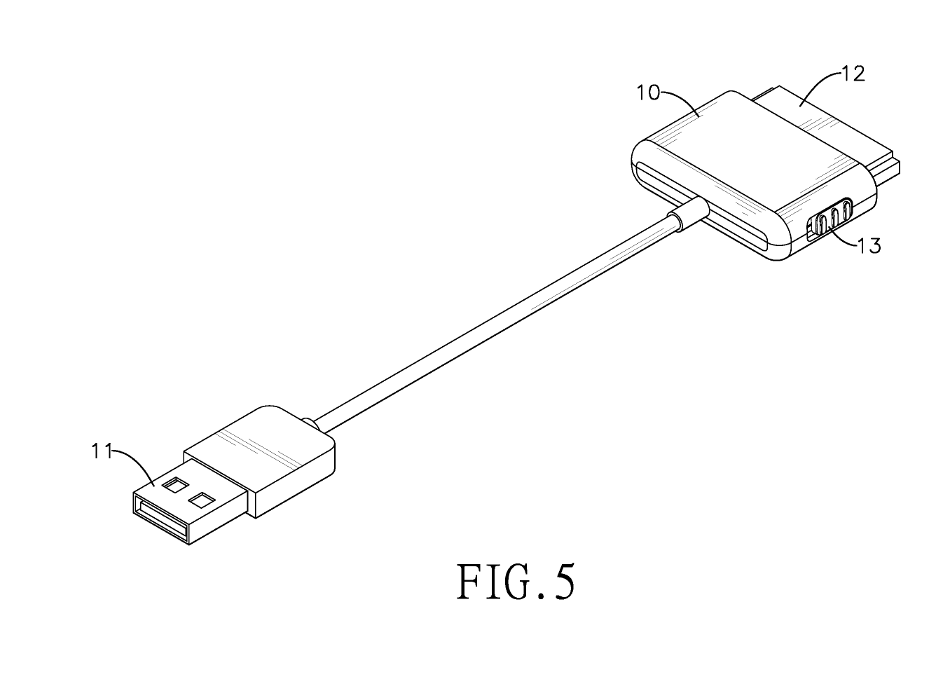

With reference to FIG. 5, a second embodiment of a charging converter in accordance with the present invention differs from the first embodiment in that the first protocol interface 11 mounted on one end of the body 10 is a USB plug. The second protocol interface 12 is still a 30-pin connector.

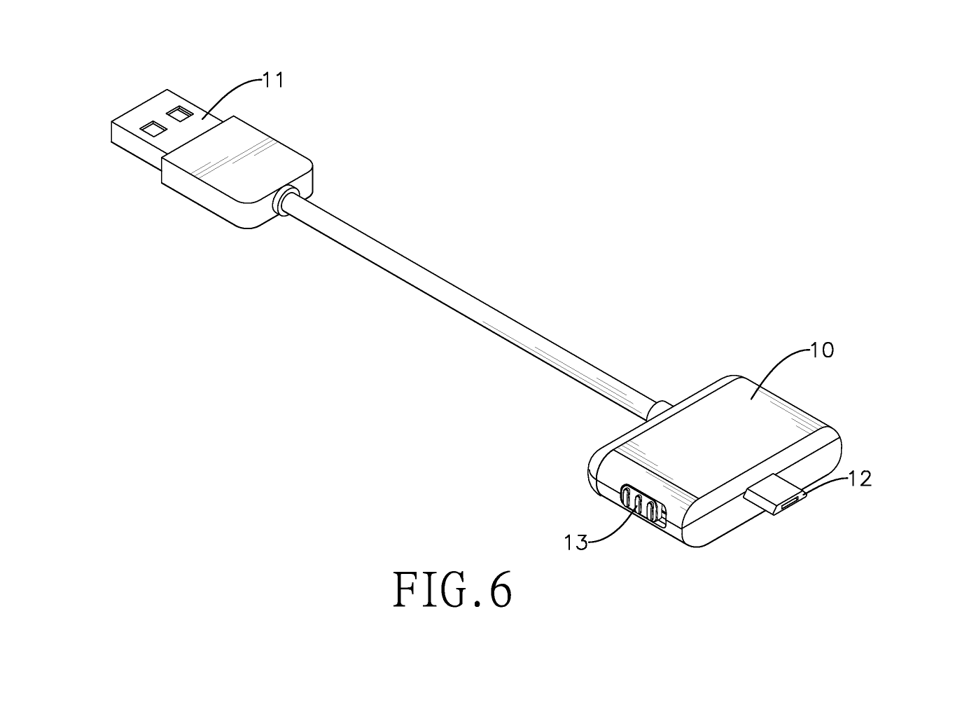

With reference to FIG. 6, a third embodiment of a charging converter in accordance with the present invention differs from the first embodiment in that the first protocol interface 11 is a USB plug connected to the body 10 through a cable and the second protocol interface 12 is a Micro-B USB plug. The USB plug can be directly connected to a USB socket of a computer and the Micro-B USB plug can be connected to a charging socket of a cell phone constituted by a Micro-B USB socket.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A charging converter comprising:
a body having a switching circuit therein;
a first protocol interface mounted on the body, being a USB (Universal serial bus)-based interface, and having a power pin, a ground pin and two data pins;
a second protocol interface mounted on the body and having:
a power pin connected to the power pin of the first protocol interface;
a ground pin connected to the ground pin of the first protocol interface; and
two data pins connected to the two data pins of the first protocol interface through the switching circuit; and
a switch mounted on the body, connected to the switching circuit of the body, and selectively switching to enter a synchronous mode and a fast charging mode through the switching circuit, wherein the power pin and the data pins of the first protocol interface are respectively connected to the power pin and the data pins of the second protocol interface at the synchronous mode, and the power pin of the first protocol interface is connected to the power pin of the second protocol interface at the fast charging mode.

2. The charging converter as claimed in claim 1, wherein the first protocol interface is a female Micro-B USB interface.

3. The charging converter as claimed in claim 1, wherein the first protocol interface is a male USB interface.

4. The charging converter as claimed in claim 2, wherein the second protocol interface is a 30-pin connector.

5. The charging converter as claimed in claim 3, wherein the second protocol interface is a 30-pin connector.

6. The charging converter as claimed in claim 1, wherein
the switching circuit has:
two voltage divider circuits, wherein one of the voltage divider circuits is composed of two voltage divider resistors connected in series and has a junction node connected with one end of each of the two voltage divider resistors, the other end of one of the voltage divider resistors is connected to the power pin of the second protocol interface, the other end of the other voltage divider resistor is connected to the ground, the other voltage divider circuit is composed of two voltage divider resistors connected in series and has a junction node connected with one end of each of the two voltage divider resistors, the other end of one of the voltage divider resistors is connected to the power pin of the second protocol interface, and the other end of the other voltage divider resistor is connected to the ground;
four switch points, two of the switch points connected to the data pins of the first protocol interface, the other two switch points respectively connected to the junction nodes of the two voltage divider circuits of the switching circuit; and
two common points, one of the common points connected to one of the data pins of the second protocol interface and corresponding to two of the switch points, and the other common point is connected to the other data pin of the second protocol interface and corresponding to the other two of the switch points.

7. The charging converter as claimed in claim 2, wherein
the switching circuit has:
two voltage divider circuits, wherein one of the voltage divider circuits is composed of two voltage divider resistors connected in series and has a junction node connected with one end of each of the two voltage divider resistors, the other end of one of the voltage divider resistors is connected to the power pin of the second protocol interface, the other end of the other voltage divider resistor is connected to the ground, the other voltage divider circuit is composed of two voltage divider resistors connected in series and has a junction node connected with one end of each of the two voltage divider resistors, the other end of one of the voltage divider resistors is connected to the power pin of the second protocol interface, and the other end of the other voltage divider resistor is connected to the ground;
four switch points, two of the switch points connected to the data pins of the first protocol interface, the other two switch points respectively connected to the junction nodes of the two voltage divider circuits of the switching circuit; and
two common points, one of the common points connected to one of the data pins of the second protocol interface and corresponding to two of the switch points, and the other common point is connected to the other data pin of the second protocol interface and corresponding to the other two of the switch points.

8. The charging converter as claimed in claim 3, wherein
the switching circuit has:
two voltage divider circuits, wherein one of the voltage divider circuits is composed of two voltage divider resistors connected in series and has a junction node connected with one end of each of the two voltage divider resistors, the other end of one of the voltage divider resistors is connected to the power pin of the second protocol interface, the other end of the other voltage divider resistor is connected to the ground, the other voltage divider circuit is composed of two voltage divider resistors connected in series and has a junction node connected with one end of each of the two voltage divider resistors, the other end of one of the voltage divider resistors is connected to the power pin of the second protocol interface, and the other end of the other voltage divider resistor is connected to the ground;
four switch points, two of the switch points connected to the data pins of the first protocol interface, the other two switch points respectively connected to the junction nodes of the two voltage divider circuits of the switching circuit; and
two common points, one of the common points connected to one of the data pins of the second protocol interface and corresponding to two of the switch points, and the other common point is connected to the other data pin of the second protocol interface and corresponding to the other two of the switch points.

9. The charging converter as claimed in claim 4, wherein
the switching circuit has:
two voltage divider circuits, wherein one of the voltage divider circuits is composed of two voltage divider resistors connected in series and has a junction node connected with one end of each of the two voltage divider resistors, the other end of one of the voltage divider resistors is connected to the power pin of the second protocol interface, the other end of the other voltage divider resistor is connected to the ground, the other voltage divider circuit is composed of two voltage divider resistors connected in series and has a junction node connected with one end of each of the two voltage divider resistors, the other end of one of the voltage divider resistors is connected to the power pin of the second protocol interface, and the other end of the other voltage divider resistor is connected to the ground;
four switch points, two of the switch points connected to the data pins of the first protocol interface, the other two switch points respectively connected to the junction nodes of the two voltage divider circuits of the switching circuit; and
two common points, one of the common points connected to one of the data pins of the second protocol interface and corresponding to two of the switch points, and the other common point is connected to the other data pin of the second protocol interface and corresponding to the other two of the switch points.

10. The charging converter as claimed in claim 5, wherein
the switching circuit has:
two voltage divider circuits, wherein one of the voltage divider circuits is composed of two voltage divider resistors connected in series and has a junction node connected with one end of each of the two voltage divider resistors, the other end of one of the voltage divider resistors is connected to the power pin of the second protocol interface, the other end of the other voltage divider resistor is connected to the ground, the other voltage divider circuit is composed of two voltage divider resistors connected in series and has a junction node connected with one end of each of the two voltage divider resistors, the other end of one of the voltage divider resistors is connected to the power pin of the second protocol interface, and the other end of the other voltage divider resistor is connected to the ground;
four switch points, two of the switch points connected to the data pins of the first protocol interface, the other two switch points respectively connected to the junction nodes of the two voltage divider circuits of the switching circuit; and
two common points, one of the common points connected to one of the data pins of the second protocol interface and corresponding to two of the switch points, and the other common point is connected to the other data pin of the second protocol interface and corresponding to the other two of the switch points.

11. The charging converter as claimed in claim 1, wherein the switching circuit is composed of a micro-controller unit (MCU), and the data pins of the first protocol interface and the second protocol interface are all connected to the MCU.

12. The charging converter as claimed in claim 2, wherein the switching circuit is composed of a MCU, and the data pins of the first protocol interface and the second protocol interface are all connected to the MCU.

13. The charging converter as claimed in claim 3, wherein the switching circuit is composed of a MCU, and the data pins of the first protocol interface and the second protocol interface are all connected to the MCU.

14. The charging converter as claimed in claim 4, wherein the switching circuit is composed of a MCU, and the data pins of the first protocol interface and the second protocol interface are all connected to the MCU.

15. The charging converter as claimed in claim 5, wherein the switching circuit is composed of a MCU, and the data pins of the first protocol interface and the second protocol interface are all connected to the MCU.
